(19) United States
(12) Patent Application Publication
(10) Pub. No.: US 2020/0411840 A1
(43) Pub. Date: Dec. 31, 2020

(54) LITHIUM PRIMARY BATTERY

(71) Applicant: LI-FUN TECHNOLOGY CO., LTD., Zhuzhou (CN)

(72) Inventors: Xiongwen XU, Zhuzhou (CN); Jian TU, Zhuzhou (CN)

(21) Appl. No.: 16/600,211

(22) Filed: Oct. 11, 2019

(30) Foreign Application Priority Data
Jun. 27, 2019 (CN) 201910568562.9

(51) Int. Cl. H01M 4/06; H01M 4/505; H01M 4/525; H01M 4/62

(52) U.S. Cl. CPC H01M 4/06; H01M 4/505; H01M 2004/027; H01M 4/623; H01M 2300/0042; H01M 4/525

(57) ABSTRACT

A lithium primary battery comprising a positive electrode sheet, a negative electrode sheet, a separator disposed between the positive electrode sheet and the negative electrode sheet and an electrolyte. The positive electrode comprises a current collector for the positive electrode and an active material layer for the positive electrode coated on at least one surface of the current collector for the positive electrode. The active material layer for the positive electrode comprises an active material capable of deintercalating lithium ions. The negative electrode sheet comprises a copper foil, a nickel foil, a conductive carbon paper or a steel film.

### CROSS-REFERENCES TO RELATED APPLICATIONS

This application claims priority of Chinese Application No. 201910568562.9, filed on Jun. 27, 2019, and the entire contents of which are hereby incorporated by reference.

### FIELD OF THE INVENTION

The present disclosure generally relates to the technical field of lithium batteries and, more particularly, relates to a lithium primary battery.

### BACKGROUND

A lithium primary battery uses lithium metal as a negative electrode, a solid salt or a salt dissolved in an organic solvent as an electrolyte, and a metal oxide or other solid or liquid oxidant as a positive electrode active material. Common lithium primary batteries are lithium-manganese dioxide battery, lithium-copper sulfide battery, lithium-fluorinated carbon battery, lithium-sulfur dioxide battery, and lithium-thionyl chloride battery. At present, the most commonly used lithium primary battery is lithium-manganese dioxide battery, which uses manganese dioxide as a positive electrode, metallic lithium as a negative electrode, and an electrolyte of a non-aqueous organic electrolyte. Lithium-manganese dioxide batteries are applied in a wide range of fields, mainly in commercial or household field as a power source for i.e., automatic cameras, electronic calculators, radios, flashlights, electric toys, watches, etc. In industry, lithium-manganese dioxide battery is mainly used as a power supply for marine lifesaving equipment; water, electricity, and gas smart meters; locator transmitters; and a power supply for a memory device thereof. In military equipment, it is mainly used as a power supply for communication stations, security machines, night vision devices, small jammers, landmines, naval mines, etc.

Nevertheless, in the existing lithium primary batteries, the negative electrode uses metallic lithium, e.g., a lithium strip, which is a highly active metal and reacts with water in a violent combustion, and releases flammable gas hydrogen meanwhile releasing a large amount of heat. Metallic lithium also reacts easily with nitrogen in the air to form brown lithium nitride on the surface. Lithium nitride cannot be removed after it is formed, which affects the performance of metallic lithium; and lithium nitride can produce sparks or even explode when pressed by high pressure.

Metallic lithium readily reacts with oxygen in the air to form white lithium oxide. High temperature or burning metallic lithium can explode when it comes into contact with concrete floor. Metallic lithium is soft and sticky. Metallic lithium crumbs tend to adhere to fixtures and protective garments, which increases the risk of explosion. Therefore, the assembly of the lithium primary battery must be carried out in a dry environment with a dew point ≤35° C.; and the floor of the drying room needs to be specially made, and concrete cannot be used. To further guarantee the performance of the battery meanwhile improve the safety of production, the assembly of the battery must be carried out in an argon environment. Accordingly, the conventional lithium primary battery is highly demanding on the environment.

The disclosed internal structure and materials of the lithium primary battery and the process of preparing the battery are directed to solve one or more problems set forth above and other problems.

### SUMMARY

In one aspect of the present disclosure, a lithium primary battery is provided. The lithium primary battery comprises a positive electrode sheet, a negative electrode sheet, a separator disposed between the positive electrode sheet and the negative electrode sheet and an electrolyte. The positive electrode comprises a current collector for the positive electrode and an active material layer for the positive electrode coated on at least one surface of the current collector for the positive electrode. The active material layer for the positive electrode comprises an active material capable of deintercalating lithium ions. The negative electrode sheet comprises a copper foil, a nickel foil, a conductive carbon paper, or a steel film.

In another aspect of the present disclosure, a method of preparing positive electrode sheets for lithium primary battery is provided. The method comprises the steps of: mixing a positive active material, a binder and a conductive agent according to a predetermined ratio to get a mixture; stirring the mixture in an organic solvent N, N-dimethylpyrrolidone (NMP) until a uniform mixture is formed to get a positive electrode slurry; coating the positive electrode slurry on an aluminum foil; pressing and slitting the aluminum foil into sheets to obtain positive electrode sheets; drying and completely dehydrating the positive electrode sheets; and placing the positive electrode sheets in an environment of a relative humidity of less than 30% to remain dry.

In further aspect of the present disclosure, a method of assembling lithium primary battery is provided. The method comprises the steps of: processing a positive electrode, a separator and a negative electrode into a core structure configured as a battery core; packaging the battery core with a packaging material; injecting a mixed non-aqueous organic electrolyte solution into the packaged battery core; and sealing the battery core to complete the preparation of the lithium primary battery.

### BRIEF DESCRIPTION OF THE DRAWINGS

The following drawings are merely examples for illustrative purposes according to various disclosed embodiments and are not intended to limit the scope of the present disclosure.

FIG. 1(a) is a structural diagram of an internal structure of lithium primary battery according to an embodiment of the present disclosure;

FIG. 1(b) is a cross-sectional diagram of layers in the internal structure of lithium primary battery according to an embodiment of the present disclosure;

FIG. 2 is a flowchart of preparing positive electrode sheets for lithium primary battery according to an embodiment of the present disclosure; and

FIG. 3 is a flowchart illustrating the assembly of lithium primary battery according to an embodiment of the present disclosure.

### DETAILED DESCRIPTION OF THE EMBODIMENTS

Technical solutions of the present disclosure will be described with reference to the drawings. Wherever possible, the same reference numbers will be used throughout the drawings to refer to the same or like parts. It is apparent that the described embodiments are some but not all of the embodiments of the present disclosure. Other embodiments conceived by those having ordinary skills in the art based on the described embodiments without inventive efforts are within the scope of the present disclosure. Further, in the present disclosure, the disclosed embodiments and the features of the disclosed embodiments may be combined in different ways as long as such combination does not incur any conflict.

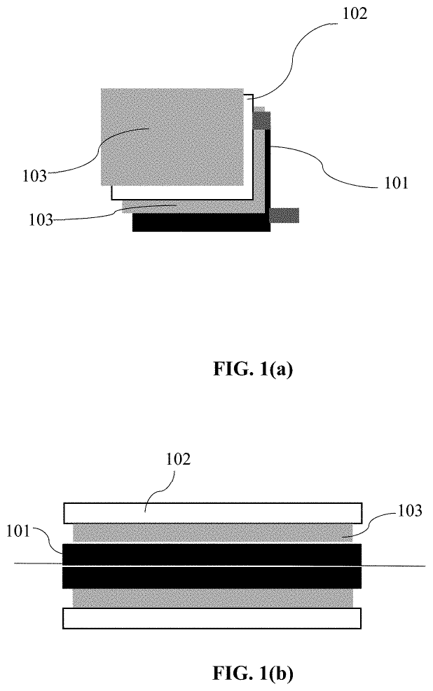

As illustrated in the present disclosure, a lithium primary battery is provided. As shown in FIG. 1(a), according to certain embodiments, the lithium primary battery may include a positive electrode sheet (101), a negative electrode sheet (102), a separator (103) disposed between the positive electrode sheet (101) and the negative electrode sheet (102), and an electrolyte. As shown in FIG. 1(b), according to certain embodiments, the positive electrode sheet (101), the separator (103) and the negative electrode sheet (102) may be stacked to form the internal structure of the battery.

The positive electrode sheet (101) may include a current collector for the positive electrode and an active material layer for the positive electrode, which may be coated on at least one surface of the current collector for the positive electrode. The active material layer for the positive electrode may include a positive electrode active material capable of deintercalating lithium ions.

A copper foil, a nickel foil, a conductive carbon paper, a steel film or other conductive foil may be adopted as a negative electrode, to replace the conventional metallic lithium negative electrode. The adoption of the conductive foil greatly decreases requirements for the dry environment (e.g., eliminates the need for a drying room and a specially manufactured floor), and largely reduces the manufacturing cost.

The separator may include any one of: a polyethylene film, a polypropylene film, a polyethylene and polypropylene composite film, a polyimide film, and a ceramic film.

The electrolyte may be a non-aqueous organic electrolyte comprising a lithium salt, a solvent and an additive. The non-aqueous organic electrolyte may be a liquid or a gel. The lithium salt may include lithium hexafluorophosphate (LiPF₆), lithium tetrafluoroborate (LiBF₄), lithium perchlorate (LiClO₄), lithium bis(oxalate)borate (LiBOB), lithium bis(fluorosulfonyl)imide (LiFSI), lithium bis(trifluoromethanesulphonyl)imide (LiTFSI), and lithium oxalyldifuoro borate (LiODFB). The solvent may include at least one solvent selected from the group consisting of: a carbonate solvent, an ether solvent, a fluorinated solvent, and carboxylic ester solvent. The carbonate solvent may include: ethylene carbonate (EC), propylene carbonate (PC), dimethyl carbonate (DMC), diethyl carbonate (DEC), and ethyl methyl carbonate (EMC). The ether solvent may include: dimethoxyethane, diethylene glycol dimethyl ether, triethylene glycol dimethyl ether, and tetraethylene glycol dimethyl ether. The fluorinated solvent may include: fluoroethylene carbonate, methyl 2,2,2-trifluoroethyl carbonate, and 1,1,2,2-tetrafluoroethyl 2,2,2-trifluoroethyl ether. The carboxylic ester solvent may include: ethyl acetate (EA), ethyl propionate (EP), propyl acetate (PA) and propyl propionate (PP).

It should be noted that, in a conventional lithium primary battery, the positive active material may be MnO₂, and the negative electrode sheet may be a metallic lithium strip. After the battery is assembled, no charging is required, and during discharge, Li in the negative lithium metal migrates into the crystal lattice of the positive MnO₂ through the electrolyte to form LiMnO₂.

In the present disclosure, the negative electrode sheet may be a layer of conductive foil material, where there is no active material. During assembly, since there may be no lithium on the negative electrode sheet, charging may be required after assembly. During charging, and Li⁺ in the active material for the positive electrode is deintercalated, and transferred to the negative electrode sheet through the electrolyte and deposited on the surface of the negative electrode sheet, to form a layer of metallic lithium. During discharging, the metallic lithium deposited on the surface of the negative electrode sheet becomes Li⁺ and is deintercalated into the electrolyte, and migrates into the crystal lattice of the active material for the positive electrode.

The negative electrode sheet may have a thickness of 5 to 200 μm. When the pole piece is thinner than 5 μm, the strength of the foil may be insufficient to support the deposition of subsequent lithium ions, and there is a risk of causing the foil to break; when the pole piece is thicker than 200 μm, there is an impact on the energy density of the battery core.

Furthermore, a positive active material may include: lithium iron phosphate, lithium manganate, lithium-rich manganese-based oxide, lithium cobalt oxide, lithium nickel-cobalt aluminate, lithium nickel-cobalt manganate, nickel-manganese binary material, lithium manganese iron phosphate, or a mixture thereof.

According to certain embodiment of the present disclosure, lithium iron phosphate slurry may be adopted as the positive electrode, to replace the conventional manganese dioxide positive electrode, mainly because the voltage platform of lithium iron phosphate is close to the voltage platform of manganese dioxide. Furthermore, during charging, lithium iron phosphate, as a positive electrode active material, providing lithium that is intercalated into the negative electrode; and during discharging, lithium is deintercalated from the negative electrode to the positive lithium iron phosphate, which does not cause the waste of lithium. It is also noteworthy that the cost of lithium iron phosphate is lower than the cost of other positive active material such as lithium nickel cobalt aluminate, nickel manganese binary material, or lithium cobalt oxide.

The active material layer for the positive electrode may further include a conductive agent and a binder. A suitable proportion of the conductive agent can better improve the electrical conductivity of the material. A binder allows the positive active material to better adhere to the current collector, which facilitates processing and preparation, and restricts the peeling between the binder and the positive active material, etc., during charging or discharging. An exceedingly high content of the binder and the conductive agent can lower the content of the active material, and accordingly, the discharge capacity per unit cell. An exceedingly low content of the binder and the conductive agent can lead to a lack of good electroconductivity and cause peeling of the positive electrode active material off the current collector.

The conductive agent for the active material layer for the positive electrode comprises at least one material selected from the group consisting of: carbon black, acetylene black, Ketjen black, carbon nanotubes, and graphene.

The binder for the active material layer for the positive electrode comprises at least one material selected from the group consisting of: polyvinylidene fluoride, polytetrafluoroethylene, polyvinylpyrrolidone, polypropylene, polyethylene, polyurethane, and polyamide.

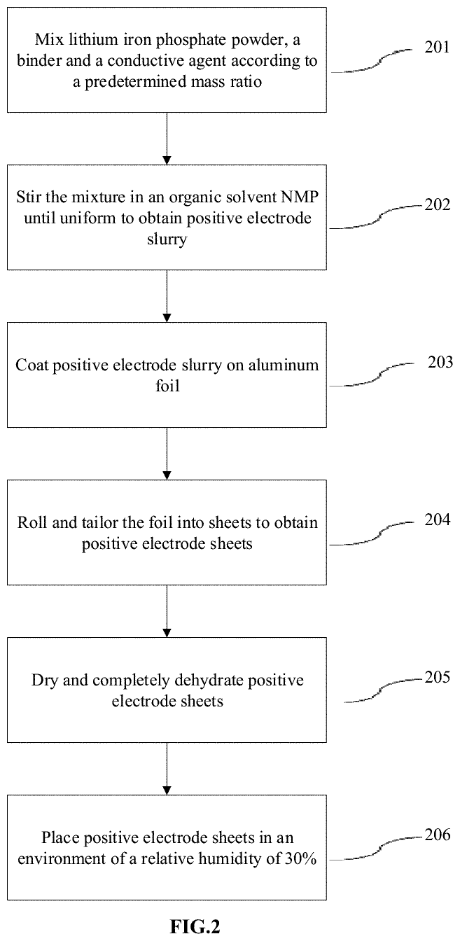

FIG. 2 is a flowchart illustrating the process of preparing positive electrode sheets for the disclosed lithium primary battery, according to certain embodiments of the present disclosure. The method may include:

Step 201: Mixing lithium iron phosphate powder, binder and a conductive agent according to a predetermined mass ratio.

Step 202: Stirring mixture in an organic solvent N, N-dimethylpyrrolidone (NMP) until a uniform mixture is formed, to get a positive electrode slurry.

Step 203: Coating positive electrode slurry on an aluminum foil.

Step 204: Pressing and tailoring the aluminum foil into sheets to get positive electrode sheets for the battery.

Step 205: Drying and completely dehydrating the positive electrode sheets.

Step 206: Placing the positive electrode sheets in an environment of a relative humidity of less than 30% for remaining dry.

According to step 201, in certain embodiments, lithium iron phosphate powder, binder and a conductive agent are well mixed according to a predetermined mass ratio, e.g., 92:4:4. The binder here is polyvinylidene fluoride (PVDF), and the conductive agent are carbon black and carbon nanotubes. The mixture then dispersed in the organic solvent N, N-dimethylpyrrolidone (NMP); and according to step 202, the mixture is stirred until a uniform mixture is formed, to obtain a positive electrode slurry. According to step 203, the positive electrode slurry is coated on an aluminum foil. According to step 204, the aluminum foil is pressed and slit into sheets to obtain the positive electrode sheets (101) for the battery. As illustrated in step 205, the positive electrode sheet (101) is dried and completely dehydrated, and placed in an environment of a relative humidity of less than 30% to remain dry.

The assembly of the battery is carried out under a normal, non-dry environment. This greatly decreases the requirements for the environment during the assembly process, improves the safety of the assembly process, and reduces the manufacturing cost in terms of avoiding the operating cost of the drying room, etc.

As shown in FIG. 1(a), the positive electrode sheet (101) and the negative electrode sheet (102) may be separated by the separator (103), to form the internal structure of the battery. The separator may be a porous polyethylene and polypropylene composite film, which is inserted between a 50 μm copper foil for the negative electrode and the positive electrode sheet. As illustrated in FIG. 1(b), the positive electrode sheet (101), the separator (103) and the negative electrode sheet (102) may be then stacked to form the layer of the battery core.

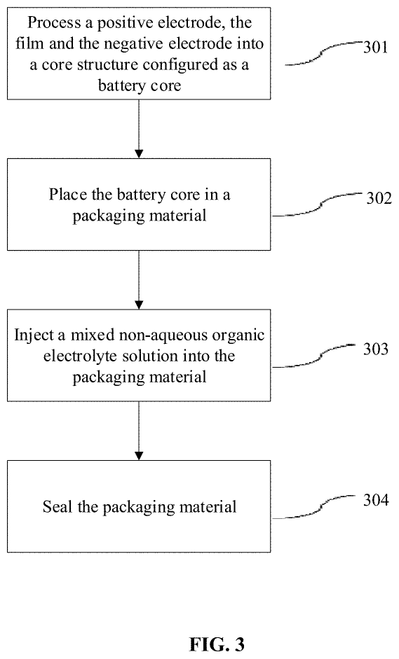

FIG. 3 is a flowchart illustrating the process of assembling the battery, to complete the preparation of the lithium primary battery according to certain embodiments.

Step 301: Processing the positive electrode (101), the separator (103) and the negative electrode (102) into a core structure as a battery core.

Step 302: Placing the processed battery core in a packaging material.

Step 303: Injecting a mixed non-aqueous organic electrolyte solution into the packaging material.

Step 304: Sealing the battery core to complete the preparation of the lithium primary battery.

The stack of the positive electrode sheet (101), the film (103) and the negative electrode sheet (102) may be laminated, or wound, or wound and laminated to form a battery core.

The packaging material used to package the battery core is any one of: an aluminum shell, a steel shell, and a polymer flexible packaging material. The polymer flexible packaging material may include: an aluminum plastic film, and a steel plastic film.

According to certain embodiments, the separator, the positive electrode and the negative electrode are wound into a square core according to 301 and placed inside an aluminum shelled packaging material according to 302. As illustrated in step 303, a mixed non-aqueous organic electrolyte solution of propylene carbonate, ethylene glycol dimethyl ether and 1 mol/L lithium hexafluorophosphate is injected in the aluminum shelled packaging material, which is then sealed to complete the preparation of the lithium primary battery according to step 304.

According to step 201, in certain embodiments, lithium iron phosphate powder, binder polytetrafluoroethylene, conductive additive carbon black and graphene are well mixed in a mass ratio of 94:3:3. As illustrated in step 202, the mixture then dispersed in the organic solvent N, N-dimethylpyrrolidone (NMP) and are stirred until a uniform mixture is formed, to obtain a positive electrode slurry. Subsequently, under step 203, the positive electrode slurry is coated on an aluminum foil. According to step 204, the foil is pressed and slit into sheets to obtain positive electrode sheets (101) for the battery. As shown in step 205, the positive electrode sheet (101) is dried and completely dehydrated; and according to step 206, it is then placed in an environment of a relative humidity of less than 30% to remain dry.

As shown in FIG. 1(a), the separator (102) here is a porous polyimide film, which is interposed between a 5 μm nickel foil for a negative electrode and a positive electrode sheet. The assembly of the battery is carried out under a normal environment. As illustrated in the steps 301-304 of FIG. 3, the positive electrode, the separator, and the negative electrode are wound into a cylindrical core, to obtain a battery core, which is placed in a steel shell. A mixed non-aqueous organic electrolyte solution of ethylene carbonate, diethylene glycol dimethyl ether and 1 mol/L lithium hexafluorophosphate is injected into the shell. The shell is then sealed to complete the preparation of the lithium primary battery.

According to the steps 201 to 206 of FIG. 2, in certain embodiments, a lithium iron phosphate powder, binder polyurethane, conductive additive carbon nanotubes and graphene may be well mixed in a mass ratio of 96:2:2, then dispersed in an organic solvent N,N-dimethylpyrrolidone (NMP) and are stirred until the mixture is uniform, to obtain a positive electrode slurry. The positive electrode slurry may be coated on an aluminum foil, which is then pressed and slit into sheets to obtain positive electrode sheets for the battery. After the positive electrode sheet is dried and completely dehydrated, it may be placed in an environment of a relative humidity of less than 30% to remain dry for later use.

The assembly of the battery may be carried out under a normal environment. As illustrated in FIG. 1(a), a porous ceramic film which plays a role of the separator (103) is inserted between the 200 μm conductive carbon paper and the positive electrode sheet (101).

As illustrated in the steps 201-206 of FIG. 2, the separator, the conductive carbon paper and the positive electrode may be laminated and processed to obtain a battery core, which is packaged in an aluminum plastic film. A mixed non-aqueous organic electrolyte of ethylene carbonate, propylene carbonate, triethylene glycol dimethyl ether, 1,1,2,2-tetrafluoroethyl, 2,2,2-trifluoroethyl ether and 1 mol/L lithium hexafluorophosphate is inserted into the aluminum plastic film, which is then sealed to complete the preparation of the lithium primary battery.

According to the steps 201 to 206 of FIG. 2, in certain embodiments, lithium iron phosphate powder, binder polyamide, conductive additive carbon black, acetylene black and Ketjen black is well mixed in a mass ratio of 98:1:1, then dispersed in an organic solvent, N,N-dimethylpyrrolidone (NMP) and are stirred until the mixture becomes uniform to obtain a positive electrode slurry. The positive electrode slurry is coated on an aluminum foil, which is then pressed and slit into sheets to obtain positive electrode sheets of the battery. The positive electrode sheet is dried and completely dehydrated, and then dried in an environment of a relative humidity of less than 30% for later use.

The assembly of the battery is carried out under a normal environment. As illustrated in FIG. 1(a), a polyethylene film which plays a role of the separator (103) is inserted between the conductive carbon paper of 100 μm and the positive electrode sheet (101).

As illustrated in the steps 201-206 of FIG. 2, the carbon paper, polyethylene film, and the positive electrode sheet are wound into a cylindrical battery core, which is placed into a steel shell. A mixed non-aqueous organic electrolyte solution of ethylene carbonate, propylene carbonate, dimethyl carbonate, tetraethylene glycol dimethyl ether, fluoroethylene carbonate and 1 mol/L lithium hexafluorophosphate is injected into the shell, which is then sealed to complete the preparation of a lithium primary battery.

According to the steps 201 to 206 of FIG. 2, in certain embodiments, lithium iron phosphate powder, binder polyamide, conductive additive carbon black, acetylene black and Ketjen black are well mixed in a mass ratio of 90:5:5, then dispersed in an organic solvent, N,N-dimethylpyrrolidone (NMP) and are stirred until a uniform mixture is formed to obtain a positive electrode slurry. The positive electrode slurry is coated on an aluminum foil, which is then pressed and slit into sheets to obtain positive electrode sheets of the battery. The positive electrode sheet is dried and completely dehydrated, and then dried in an environment of a relative humidity of less than 30% for later use.

The assembly of the battery is carried out under a normal environment. As illustrated in FIG. 1(a), a polypropylene film which plays a role of the separator (103) is interposed between the 150 μm conductive carbon paper for the negative electrode (102) and the positive electrode sheet (101).

As illustrated in the steps 201-206 of FIG. 2, the carbon paper, the positive electrode sheet, and the polypropylene film are laminated and wound into a battery core, which is packaged with an aluminum plastic film. A mixed non-aqueous organic electrolyte solution of vinyl carbonate, propylene carbonate, diethyl carbonate, ethyl methyl carbonate, methyl trifluoroethyl carbonate and 1 mol/L of lithium hexafluorophosphate is injected into the aluminum plastic film, which is then sealed to complete the preparation of a lithium primary battery.

It should be noted that the above embodiments are merely provided for describing the technical solutions of the present invention, and not intended to limit the scope thereof. Although detailed descriptions are provided regarding the various embodiments, those skilled in the art can appreciate that the disclosed technical solutions can be modified, or some or all of the technical features can be equivalently replaced without inventive efforts. Such modifications or replacements will be readily apparent to those skilled in the art, and do not depart from the spirit or scope of the invention.

What is claimed is:

1. A lithium primary battery, comprising:
a positive electrode sheet, the positive electrode sheet including a current collector and an active material layer coated on at least one surface of the current collector, the active material layer being made of an active material capable of deintercalating lithium ions;
a negative electrode sheet, the negative electrode sheet including one of a copper foil, a nickel foil, a conductive carbon paper and a steel film;
a separator disposed between the positive electrode sheet and the negative electrode sheet; and
an electrolyte.

2. The lithium primary battery according to claim 1, wherein the negative electrode sheet has a thickness of 5 to 200 μm.

3. The lithium primary battery according to claim 1, wherein the active material for the positive electrode comprises: lithium iron phosphate, lithium manganate, lithium-rich manganese-based oxide, lithium cobalt oxide, lithium nickel-cobalt aluminate, lithium nickel-cobalt manganate, nickel-manganese binary material, lithium manganese iron phosphate, or a mixture thereof.

4. The lithium primary battery according to claim 1, wherein:
the active material layer for the positive electrode further comprises a conductive agent and a binder; and
the mass ratio among the active material, the conductive agent, and the binder is 90˜98:1˜5:1˜5.

5. The lithium primary battery according to claim 4, wherein the conductive agent comprises at least one material selected from the group consisting of: carbon black, acetylene black, Ketjen black, carbon nanotubes, and graphene.

6. The lithium primary battery according to claim 4, wherein the binder comprises at least one material selected from the group consisting of: polyvinylidene fluoride, polytetrafluoroethylene, polyvinylpyrrolidone, polypropylene, polyethylene, polyurethane, and polyamide.

7. The lithium primary battery according to claim 1, wherein the separator comprises any one of: polyethylene film, a polypropylene film, a polyethylene and polypropylene composite film, a polyimide film, and a ceramic film.

8. The lithium primary battery according to claim 1, wherein the electrolyte is a non-aqueous organic electrolyte, comprises a lithium salt, a solvent and an additive;
wherein:
the non-aqueous organic electrolyte is one of: a liquid and a gel; the lithium salt comprises lithium hexafluorophosphate, lithium tetrafluoroborate, lithium perchlorate, lithium bis(oxalate)borate, lithium bis(fluorosulfonyl)imide, lithium bis(trifluoromethanesulphonyl)imide, and lithium oxalyldifuoro borate; and the solvent comprises at least one solvent selected from the group consisting of: a carbonate solvent, an ether solvent, a fluorinated solvent, and carboxylic ester solvent.

9. The lithium primary battery according to claim 8, wherein the carbonate solvent comprises: ethylene carbonate (EC), propylene carbonate (PC), dimethyl carbonate (DMC), diethyl carbonate (DEC), and ethyl methyl carbonate (EMC).

10. The lithium primary battery according to claim 8, wherein the ether solvent comprises: dimethoxyethane, diethylene glycol dimethyl ether, triethylene glycol dimethyl ether, and tetraethylene glycol dimethyl ether.

11. The lithium primary battery according to claim 8, wherein the fluorinated solvent comprises: fluoroethylene carbonate, methyl 2,2,2-trifluoroethyl carbonate, and 1,1,2,2-tetrafluoroethyl 2,2,2-trifluoroethyl ether.

12. The lithium primary battery according to claim 8, wherein the carboxylic ester solvent comprises: ethyl acetate, ethyl propionate, propyl acetate and propyl propionate.

13. The lithium primary battery according to claim 1, wherein the positive electrode sheet, the separator, and the negative electrode sheet are sequentially stacked, and laminated, or wound, or laminated and wound, to form a battery core.

14. The lithium primary battery according to claim 13,
wherein a packaging material of the battery core is an aluminum shell, a steel shell, or a polymer flexible packaging material,
wherein the polymer flexible packaging material comprises an aluminum plastic film and a steel plastic film.

15. A method of preparing positive electrode sheets for lithium primary battery, comprising:
mixing lithium iron phosphate powder, a binder and a conductive agent according to a predetermined mass ratio to get a mixture;
stirring the mixture in an organic solvent N, N-dimethylpyrrolidone (NMP) until a uniform mixture is formed to get a positive electrode slurry;
coating the positive electrode slurry on an aluminum foil;
pressing and slitting the aluminum foil into sheets to obtain positive electrode sheets;
drying and completely dehydrating the positive electrode sheets; and
placing the positive electrode sheets in an environment of a relative humidity of less than 30% for remaining dry.

16. The method of preparing positive electrode sheets for lithium primary battery according to claim 15, wherein the binder comprises at least one material selected from the group consisting of: polyvinylidene fluoride, polytetrafluoroethylene, polyvinylpyrrolidone, polypropylene, polyethylene, polyurethane, and polyamide.

17. The method of preparing positive electrode sheets for lithium primary battery according to claim 15, wherein the conductive agent comprises at least one material selected from the group consisting of: carbon black, acetylene black, Ketjen black, carbon nanotubes, and graphene.

18. The method of preparing positive electrode sheets for lithium primary battery according to claim 15, wherein the predetermined mass ratio is 90˜98:1˜5:1˜5.

19. A method of assembling lithium primary battery, comprising:
processing a positive electrode, a separator and a negative electrode into a core structure configured as a battery core;
placing the battery core in a packaging material;
injecting a mixed non-aqueous organic electrolyte solution into the packaging material; and
sealing the packaging material.

20. The method of assembling lithium primary battery according to claim 19, wherein:
the non-aqueous organic electrolyte solution comprises a lithium salt, a solvent and an additive, the non-aqueous organic electrolyte solution is one of: a liquid and a gel;
the lithium salt comprises lithium hexafluorophosphate, lithium tetrafluoroborate, lithium perchlorate, lithium bis(oxalate)borate, lithium bis(fluorosulfonyl)imide, lithium bis(trifluoromethanesulphonyl)imide, and lithium oxalyldifuoro borate; and
the solvent comprises at least one solvent selected from the group consisting of: a carbonate solvent, an ether solvent, a fluorinated solvent and a carboxylic ester solvent.
